(19) United States
(12) Patent Application Publication
(10) Pub. No.: US 2023/0251614 A1
(43) Pub. Date: Aug. 10, 2023

(54) Method for the Subtractive Machining of a Workpiece and Machining System

(71) Applicant: Siemens Aktiengesellschaft, München (DE)

(72) Inventors: Benjamin Samuel Lutz, Erlangen (DE); Raven Thomas Reisch, München (DE); Daniel Regulin, Geltendorf (DE)

(73) Assignee: Siemens Aktiengesellschaft, München (DE)

(21) Appl. No.: 18/003,589

(22) PCT Filed: Jun. 18, 2021
(86) PCT No.: PCT/EP2021/066634

§ 371 Date: Dec. 28, 2022

(30) Foreign Application Priority Data
Jun. 30, 2020 (DE) 10 2020 208 132.8
Aug. 31, 2020 (EP) 20193732.3

(51) Int. Cl. G05B 19/042; B23Q 15/12

(52) U.S. Cl. CPC G05B 19/042; B23Q 15/12; G05B 2219/35398

(57) ABSTRACT

Various embodiments of the teachings herein include a method for subtractive machining of a workpiece using a tool. The method may include: detecting at least two process variables of a machining process; and using the process variables to infer a wear on the tool. The process variables are passed on to a neural network which assigns each process variable a respective degree of wear independently of the other. The wear is inferred by means of a logic on the basis of the respective degrees of wear. The process variables are each selected from the group consisting of: a shape of the tool, an operating current, an operating voltage, maintenance and servicing information, and interruption information of the machining. Detecting the shape of the tool includes imaging using a camera and/or a scanner.

### CROSS-REFERENCE TO RELATED APPLICATIONS

This application is a U.S. National Stage Application of International Application No. PCT/EP2021/066634 filed Jun. 18, 2021, which designates the United States of America, and claims priority to EP Application No. 20193732.3 filed Aug. 31, 2020, and DE Application No. 10 2020 208 132.8 filed Jun. 30, 2020, the contents of which are hereby incorporated by reference in their entirety.

### TECHNICAL FIELD

The present disclosure relates to machining. Various embodiments of the teachings herein include methods and/or systems for subtractive machining of a workpiece.

### BACKGROUND

The production costs of machine tools are composed of, among other things, a machine-specific, constant hourly machine rate as well as costs resulting from wear on the tool used. This tool wear depends upon the material to be cut, the condition of the tool and the chosen cutting conditions, and continuously rises during the cutting process, but generally not in a linear manner. If the tool wear reaches a maximum permissible wear that is defined in advance, then the tool is considered worn out. If a worn-out tool is used further, then the component quality falls during subtractive machining and the cutting power also falls drastically. By contrast, if a tool that is not worn out is swapped out too soon, then the tool costs rise due to the unused tool use time and an increased outlay occurs due to additional setup work.

Consequently, an evaluation of the wear on a tool used during the machining is a critical parameter during the subtractive machining of workpieces. Measures known to date for evaluating the wear on a tool require the tool to be removed or a more-or-less accurate estimation based on assumptions that are made. In principle, further data could also be used to evaluate a tool wear. Previous approaches do not function in a reliable manner, however.

For example, approaches for automating the assessment of a tool wear are known from the publications U.S. Pat. No. 8,781,982 B1 and JP H11 267949 A. EP 3 399 466 A1 describes a training method for image recognition.

### SUMMARY

The teachings of the present disclosure include improved methods and/or systems for subtractive machining, in which a wear on the tool used during the machining can be better evaluated. For example, some embodiments of the teachings herein include a method for subtractive machining of a workpiece (WS) by means of a tool (FRAE, WSPL), in which at least two process variables (BIDA, EVEN, TISE) of the machining are detected and used to infer a wear on the tool (FRAE, WSPL), characterized in that the at least two process variables (BIDA, EVEN, TISE) are passed on to a neural network (IMCN, EVCN, TSCN) in each case, which assigns the process variable (BIDA, EVEN, TISE) a degree of wear independently of the other in each case, wherein a wear on the tool (FRAE, WSPL) is inferred by means of a logic on the basis of the plurality of degrees of wear, and wherein the at least two process variables (BIDA, EVEN, TISE) comprise a shape (BIDA) of the tool (FRAE, WSPL) and/or an operating current and/or an operating voltage (TISE) for operating the tool (FRAE, WSPL) and/or maintenance and servicing information and/or interruption information (EVEN) of the machining, wherein the shape (BIDA) of the tool (FRAE, WSPL) is detected by means of imaging, which imaging takes place by means of a camera and/or by means of a scanner.

In some embodiments, one or more or all of the process variables (BIDA, EVEN, TISE) are detected in a time-resolved manner, e.g. repeatedly, in particular periodically, and/or continuously.

In some embodiments, at least one or more of the neural networks (EVCN, IMCN, TSCN) forms or comprises a deep neural network and/or a convolutional neural network and/or a multilayer perceptron and/or a long short-term memory and/or an autoencoder.

In some embodiments, the wear on the tool (FRAE, WSPL) is inferred by means of a binary logic.

In some embodiments, the tool (FRAE, WSPL) is or comprises a miller (FRAE) and/or a drill and/or an indexable insert (WSPL).

In some embodiments, the process variables (BIDA, EVEN, TISE) are detected by means of one or more sensors (CAM, CON) and/or a log file (LOGD).

In some embodiments, when a wear on the tool is inferred, the tool is swapped and/or the machining is interrupted.

As another example, some embodiments include a machining system for subtractive machining of a workpiece according to a method as claimed in one of the preceding claims, which has a tool (FRAE) for machining the workpiece (WS) as well as at least assessment facilities (EVAU, BIAU, TSAU) for assessing each of at least two process variables (BIDA, EVEN, TISE) of the machining, which in each case comprise a neural network (EVCN, IMCN, TSCN), which is embodied and configured for assigning a degree of wear to the process variable in each case (BIDA, EVEN, TISE), wherein the machining system (20) has an establishing unit (IND) which is embodied and configured to establish a wear on the tool (FRAE, WSPL) on the basis of the plurality of degrees of wear.

In some embodiments, the system further comprises detection means (CAM, CON, LOGD) for detecting the at least two process variables (BIDA, EVEN, TISE), wherein the detection means comprise at least one camera and/or a scanner (CAM) as well as a current detection means (CON) and/or a detection means for entries in a log file (LOGD).

### BRIEF DESCRIPTION OF THE DRAWINGS

The teachings herein are is explained in more detail below with reference to an exemplary embodiment illustrated in the drawing, in which:

FIG. 1 shows a flow diagram of an exemplary embodiment of the method incorporating teachings of the present disclosure in a schematic outline; and

FIG. 2 shows a system incorporating teachings of the present disclosure for carrying out one or more of the methods according to FIG. 1.

### DETAILED DESCRIPTION

In some embodiments of the teachings herein, in a method for subtractive machining of a workpiece by means of a tool, at least two process variables of the machining are detected and used and passed on to a neural network in each case. In the method, each of the neural networks assigns the process variable a degree of wear on the tool, wherein a wear on the tool is inferred on the basis of the plurality of degrees of wear.

In some embodiments, a wear on the tool is inferred by means of a data fusion of the at least two process variables. In this manner, it is possible to infer a wear on the tool in a reliable manner. In particular, it is possible to exclude false-negative events in a simple manner, by a wear on the tool already being inferred when, on the basis of a process variable, a corresponding degree of wear on the tool is already inferred which suggests a wear on the tool. In some embodiments, it is possible to infer a wear on the tool in such a manner that a machining time of one or more successively manufactured workpieces is minimized or a minimum tool wear is targeted. In some embodiments, the tool is swapped when a wear on the tool is inferred.

Unlike in known solutions, multimodal data is used, i.e. a data fusion of the at least two process variables, in order to increase the accuracy of inferring a wear on the tool. In some embodiments, costs can advantageously be saved during the subtractive machining of the workpiece, as additional costs are not incurred due to premature tool wastage nor are consequential costs incurred due to damage to the workpiece resulting from a worn-out tool.

In some embodiments, by means of precisely inferring a wear on the tool, it is possible to achieve an increased machining quality. In particular, rejection of workpieces due to a worn-out tool can be reduced. Due to the easily automatable method, manual checking of the tool is not necessary, meaning that it is possible to save time and personnel costs.

In some embodiments, one or more or all of the process variables are detected in a time-resolved manner, e.g. repeatedly, in particular periodically, and/or continuously. In this development, the temporal process behavior of the machining of the workpiece is taken into consideration. In this manner, in particular the current process situation can be used during the machining of the workpiece. A drifting of process parameters therefore does not impair the reliability of the method in this development, for example.

In some embodiments, the at least two process variables comprise a shape of the tool and/or an operating current and/or an operating voltage for operating the tool and/or maintenance and servicing information and/or interruption information. In some embodiments, the shape of the tool is detected by means of imaging, in particular by means of a camera and/or by means of a scanner, e.g. a laser scanner. Expediently, on the basis of a roundness of a cutting tool, for example, a wear on the tool can be reliably inferred. In this manner, visual effects can be taken into consideration when inferring a wear.

An operating current and/or an operating voltage during operation of the tool, during the machining, also supplies important information, which may be relevant to a wear on the tool. Thus, for example, an operating current during operation of a miller supplies information regarding a torque to be applied while machining the workpiece by means of the miller. In this manner, from the operating current of the miller, it is possible to infer a wear on the miller, also referred to as milling tool, when the torque of the miller and consequently the operating current of the miller changes in an unusually rapid or drastic manner.

Maintenance and servicing information and/or interruption information, in particular in the context of the remaining process variables, supply additional information, which is of significance for inferring a wear on the tool, such as a miller in particular. Thus, in particular, a swap that took place briefly or an inspection of the tool and/or an unusually extended maintenance interval during maintenance of a machining system used to perform the methods may give valuable information for interpreting the process variables.

In some embodiments, at least one or more of the neural networks forms or comprises a deep neural network and/or a convolutional neural network and/or a multilayer perceptron and/or a long short-term memory and/or an autoencoder. By means of a convolutional neural network, images of tools can be classified as a function of the degree of wear. In this context, the convolutional neural network may have different architectures. Expediently, the convolutional neural network has between 8 and 12 layers, in particular 10 layers, of which 6 are convolutional layers and 4 are dense layers and/or fully connected layers, and optionally has a rectifier activation function, which has good results for a classification of image data in particular.

In some embodiments, neural networks can be used for efficient time series classification of current data in particular. Preferably, the neural network has a multilayer perceptron or a long short-term memory. For the multilayer perceptron, first properties of the time series are defined, which are passed on to the neural network, i.e. the time series is first preprocessed, before it is passed on to the neural network. Suitable in the case of current data or torques of the tool are an average value and/or a standard deviation and/or an integrated current value up to the recording of an expedient image of the tool likewise used in the methods. Advantageously, a long short-term memory does not require preprocessing of a time series.

In some embodiments, a wear on the tool is expediently inferred by means of a logic, in particular a binary logic. By means of the at least two present degrees of wear obtained independently, these may be used in combination to infer the wear on the tool. In some embodiments, the degrees of wear are combined with one another, by a resulting degree of wear being determined in the sense of a quantitative inference by means of the logic. In some embodiments, it is possible to formulate a wear on the tool as a qualitative statement, i.e. a statement of whether or not wear on the tool is present.

In some embodiments, the binary logic that is used may reduce a risk of false negative inferences of a wear on the tool.

In some embodiments, the tool comprises a miller and/or a drill and/or an indexable insert.

In some embodiments, the process variables are detected by means of one or more sensors and/or a log file. In some embodiments, sensors in the form of a camera, in particular for detecting a shape of a tool, and/or an ammeter, in particular for detecting an operating current for operating the tool, and/or a voltmeter, in particular for detecting an operating voltage for operating the tool, are used.

In some embodiments, when a wear on the tool is inferred, the tool may be swapped and/or the machining is interrupted.

The machining systems for subtractive machining of a workpiece may employ one or more of the methods as described herein. The machining system has a tool for machining the workpiece as well as at least assessment facilities for assessing each of at least two process variables of the machining, which in each case comprise a neural network, which is embodied and configured for assigning a degree of wear to the process variable in each case. The machining system also has an establishing unit which is embodied and configured to establish a wear on the tool on the basis of the plurality of degrees of wear.

In some embodiments, the machining system has detection means which are arranged and embodied for detecting the at least two process variables.

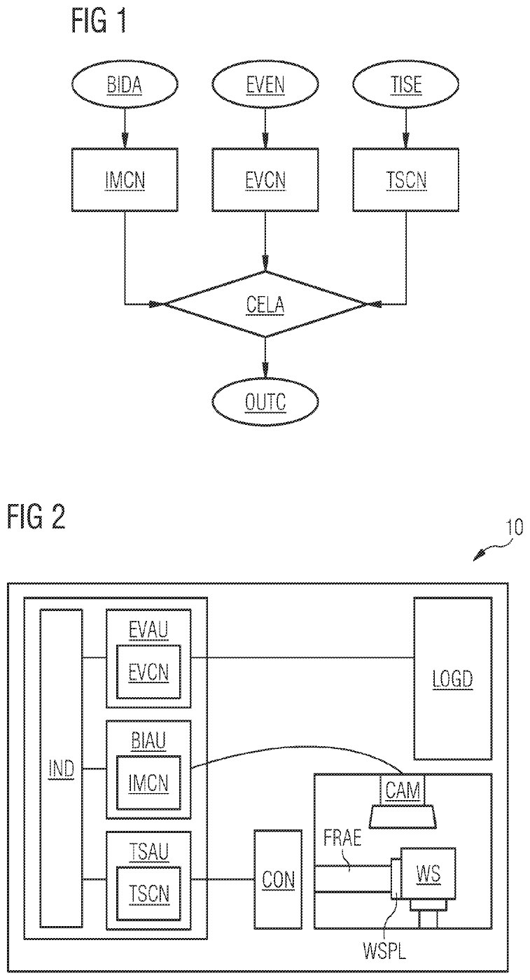

The method incorporating teachings of the present disclosure shown in FIG. 1 is a method for subtractive machining of a workpiece. In the exemplary embodiment shown, the method is a milling method. In alternative exemplary embodiments not shown separately, the method involves a turning method.

In the milling method, for machining a workpiece WS, millers FRAE are used, into which indexable inserts WSPL made of a hard ceramic are screwed. These millers FRAE with the indexable inserts WSPL form tools of a manufacturing system 10. In further exemplary embodiments not shown separately, other tools may be used on an alternative or additional basis.

During the subtractive machining of the tool WS, the indexable inserts WSPL wear out. In order to identify when these indexable inserts WSPL should ideally be swapped, as shown in FIG. 1, a plurality of input data items are used in order to observe the wear on the indexable inserts WSPL and track it over time. To this end, the manufacturing system 10 has a camera CAM, which is embodied to record images of the indexable insert WSPL when the indexable insert WSPL is stationary, for example between machining steps or while the workpiece WS is being swapped. In the manufacturing system 10, it is not necessary to remove the indexable insert WSPL to record images.

The images are recorded at regular points in time and the resulting image data BIDA is supplied to an image assessment facility BIAU.

The image assessment facility BIAU comprises a deep neural network IMCN. In the exemplary embodiment shown, the deep neural network is a convolutional neural network. The deep neural network receives the image data BIDA and classifies the image data BIDA on the basis of wear classes obtained in a training run of the deep neural network IMCN. The wear classes reflect a degree of the wear on the indexable insert WSPL. The wear classes contain an isolated note, exclusively obtained from the image data BIDA, stating whether or not the degree of wear on the indexable insert WSPL suggests a swapping of the indexable insert WSPL.

On the other hand, in the manufacturing system 10, it is not just image data BIDA of the miller FRAE and the indexable insert WSPL connected thereto that is detected. Time series data of an operating current of the miller FRAE is additionally also detected, which correlates with a torque necessary for machining the workpiece WS and consequently with a wear on the indexable insert WSPL. To this end, current detection means not explicitly shown in the drawing are arranged in a control facility CON of the manufacturing system 10, which are embodied to detect the operating current of the miller FRAE in a time-resolved manner. The current data TISE detected over time is transmitted to a current assessment facility TSAU.

The current assessment facility TASU comprises a neural network TSCN for classifying the current data TISE. The current data TISE that is detected in a time-resolved manner forms a time series. For suitable analysis of the time series, the neural network TSCN is embodied as a multilayer perceptron. The time series is edited for the neural network TSCN by means of the current assessment facility TSAU in such a manner that first certain properties of the time series of current data TISE are determined, in the exemplary embodiment shown an average value and a standard deviation of the current data TISE detected. Furthermore, as a further property of the time series, an integrated current value between two images detected by the camera CAM in each case is detected. These properties of the time series are now passed on to the neural network TSCN.

In further exemplary embodiments not shown separately, instead of the multilayer perceptron, a long short-term memory can be used. In such exemplary embodiments, no prior determination of properties of the time series is necessary. The neural network TSCN classifies the current data TISE into current classes, which indicate a degree of wear on the indexable insert WSPL. The current classes contain an isolated note, exclusively obtained from the current data TISE, stating whether or not the degree of wear on the indexable insert WSPL suggests a swapping of the indexable insert WSPL.

In some embodiments, a further influencing variable is used to determine a wear on the indexable insert WSPL. This influencing variable forms a time series of entries in a log file LOGD of the manufacturing system 10. The entries have information regarding the swapping of indexable inserts WSPL and monitoring results of clamping situations of the miller FRAE. The entries further contain repair activities on the manufacturing system 10. This time series is transmitted to a log data assessment facility EVAU, which ascertains a classification of operating states of the manufacturing system 10 by means of a neural network EVCN. The classification of operating states of the manufacturing system 10 assigns the operating state of the manufacturing system 10 to a class, which corresponds to a certain assumed degree of wear on the indexable insert WSPL.

By means of the previously described methods, three independent values are therefore ascertained for ascertaining a degree of wear on the indexable insert WSPL. These values are transmitted to a degree of wear determination facility OUTC, which undertakes a final evaluation of the degree of wear on the indexable insert WSPL on the basis of the independent values. To this end, the degree of wear determination facility OUTC processes the values supplied by the log data assessment facility EVAU and the image assessment facility BIAU as well as the current assessment facility TASU by means of a binary logic. In the exemplary embodiment shown, the binary logic is consequently optimized to reduce false negative values, i.e. the degree of wear determination facility OUTC determines a degree of wear on the indexable insert WSPL, which requires the indexable insert WSPL to be swapped, when already a single one of the facilities of the group comprising the log data assessment facility EVAU and the image assessment facility BIAU and the current assessment facility TSAU establishes such a degree of wear. In some embodiments, the binary logic is optimized for deviating aims of the method, namely for a minimal process time or for a minimum tool wear.

To perform the method, the neural network TSCN and the neural network EVCN as well as the deep neural network IMCN have been trained in a comprehensive manner with a large number of machining procedures with indexable inserts WSPL before the method is performed.

What is claimed is:

1. A method for subtractive machining of a workpiece using a tool, the method comprising:
detecting at least two process variables of a machining process;
using the at least two process variables to infer a wear on the tool:
wherein the at least two process variables are passed on to a neural network which assigns each process variable a respective degree of wear independently of the other;
wherein the wear is inferred by means of a logic on the basis of the respective degrees of wear; and
wherein the at least two process variables are each selected from the group consisting of: a shape of the tool, an operating current, an operating voltage, maintenance and servicing information, and interruption information of the machining;
wherein detecting the shape of the tool includes imaging using a camera and/or a scanner.

2. The method as claimed in claim 1, wherein at least one of the process variables is detected in a time-resolved manner.

3. The method as claimed in claim 1, wherein the neural network comprises a deep neural network, a convolutional neural network, a multilayer perceptron, a long short-term memory, and/or an autoencoder.

4. The method as claimed in claim 1, wherein the wear on the tool is inferred using a binary logic.

5. The method as claimed in claim 1, wherein the tool comprises a miller, a drill, and/or an indexable insert.

6. The method as claimed in claim 1, wherein the process variables are detected using one or more sensors and/or a log file.

7. The method as claimed in claim 1, further comprising, when a wear on the tool is inferred, swapping the tool is swapped and/or interrupting the machining.

8. A machining system for subtractive machining of a workpiece, the system comprising:
a tool for machining the workpiece;
assessment facilities for assessing at least two process variables of the machining,
wherein the assessment facilities comprise a neural network for assigning a respective degree of wear to each of the at least two process variables;
an establishing unit programmed to establish a wear on the tool on the basis of the respective degrees of wear.

9. The machining system as claimed in claim 8, further comprising detectors for determining the at least two process variables;
wherein the detectors comprise a camera and/or a scanner as well as a current detector and/or a detection means for entries in a log file.
